(19) United States
(12) Patent Application Publication
(10) Pub. No.: US 2025/0012385 A1
(43) Pub. Date: Jan. 9, 2025

(54) LOW PROFILE CLAMP WITH TOLERANCE COMPENSATION

(71) Applicant: Oetiker Schweiz AG, Horgen (CH)

(72) Inventors: Steffen RICHTER, Horgen (CH); Bianca GRIMALDI, Horgen (CH); Chrisoph SCHNEEBERGER, Horgen (CH); Edoardo ROSSI, Horgen (CH); Patrick MÜLLER, Horgen (CH)

(73) Assignee: Oetiker Schweiz AG, Horgen (CH)

(21) Appl. No.: 18/764,237

(22) Filed: Jul. 4, 2024

(30) Foreign Application Priority Data
Jul. 5, 2023 (DE) 102023117722.2

(51) Int. Cl. F16L 19/00

(52) U.S. Cl. CPC F16L 19/00

(57) ABSTRACT

The present invention provides an improved tolerance compensation means 50 for a clamp structure 10 formed by a clamping band 1 with first and second end portions 2, 3 adapted to overlap each other as inner and an outer clamping band portions when installing the clamp structure 10 around an object to be fastened. The tolerance compensation means 50 includes adjacent first, second and third band regions 51-53, whereas the second band region 52 has a constant band width Wred smaller than that of the first and third band regions 51, 53.

### CROSS-REFERENCE TO RELATED APPLICATIONS

The present application claims priority to German Patent Application No. DE102023117722.2 filed on Jul. 5, 2023, hereby incorporated by reference in its entirety.

### BACKGROUND OF THE INVENTION

In order to reliably assemble a clamp structure on an object to be fastened, the object's tolerance stack must be considered. Low profile clamps, due to their fixed closing stroke, typically suffer from a limited application range and therefore reduced tolerance stack coverage capability. Therefore, clamps are provided with tolerance compensation elements to enable clamp elongation to accommodate the object's tolerance variations.

Tolerance compensation elements typically used in the art are wave profile(s) extending outwards, which are based on accumulating/storing band material which can then be plastically deformed/elongated to provide the needed compensation. Such wave-type tolerance compensation elements are, for example, described in EP 0 697 554 A1, FR 2 470 275 A1, U.S. Pat. No. 4,308,648 A, and US 2009/0313792 A1.

However, such conventional tolerance compensation waves suffer from three main disadvantages:
Their radial extension and material accumulation determines a weaker clamp resistance to impact. As a fact, wave profiles in a low profile clamp, when hit by an external body during operation, have a tendency to be elongated by the impact and therefore leading to the disengagement/spring-opening of the clamping element.
Wave compensation elements typically show a too weak behaviour when elongated. This means that the load at which they start to elongate is typically too low (refer to FEA results in FIG. 3 below), leading to decreased performance of the clamping element and therefore increasing the risk of potential leakage.
The inclusion of compensation waves in the clamp design requires the re-positioning of other features and therefore also typically increases the overall band length.

Another example of tolerance compensation elements used in the prior art are slot like openings in the band material. This is, for instance, described in EP 0 697 555 A1. U.S. Pat. Nos. 1,705,895 A, 4,998,326 A, and 4,987,651 A also suggest to enhance the stretchability by combining those slot like openings with recesses at the lateral edges of the band material.

However, these prior art solutions turned out to achieve unsatisfactory results. In particular, the shape of the slot-like tolerance compensation elements allows only limited performance regarding stretchability (or elongation) and a limited maximum resistance of the band clamp before it is broken.

### BRIEF SUMMARY OF THE INVENTION

The present invention relates to a clamp structure made from a flat metal band or strip formed into a loop to be fastened around an object of substantially circular cross-section such as a hose, pipe or boot. In particular, the present invention relates to a so-called “low profile clamp”, i.e., clamps having only small radial outward projecting parts leading to a relatively small overall radial clamp profile. Further, the present invention relates particularly to so-called stepless clamps, i.e., clamps having in their closed condition almost no uneven portions or steps at the inner circumferential surface.

An object of the present invention is to improve the overall performance of the clamp structure regarding its elongation and maximum resistance behaviour without detriment to cost and useability of the clamp.

This object is achieved by the clamp structure of the present invention. The other claims relate to preferred embodiments.

According to the present invention, the clamp structure is formed by a clamping band comprising tolerance compensation means in the form of a reduced cross-section portion, i.e., a portion in which the band width is concavely reduced from a first band width to a second band width to impart stretchability to the clamping band in its longitudinal direction. More specifically, the tolerance compensation means includes adjacent first, second and third band regions, whereas the second band region has a constant band width smaller than that of the first and third band regions.

The tolerance compensation means of the present invention is able to provide almost linear elongation (predominantly by plastic deformation) before the maximum closing force is achieved. The present invention achieves an increase of the maximum achievable stroke before breakage of the clamping element. In particular compared to compensation waves as known in the art, this solution shows the following advantages:
Having no radial extension and material accumulation, the risk of disengagement and poor impact resistance is mitigated/avoided.
Since the tolerance compensation is based on material elongation on a reduced cross-section portion, this elongation occurs at high closing force values and therefore reduces the risk of deteriorating the clamp stiffness.
The solution shows only a slight reduction of radial compression and therefore there is only a limited decrease of radial load performance.

According to a preferred embodiment, the longitudinal extension of second band region is larger than that of the first or third band region but smaller than the sum of that of the first and third band regions. This turned out to provide optimum characteristics regarding the trade-off between material elongation and maximum breakdown force.

For similar reasons, the decrease/increase of band width in the first and/or third band regions should preferably be linear, and/or symmetric with respect to a longitudinal center axis of the clamping band and/or with respect to a cross-section through the second band region orthogonal to the longitudinal direction. Moreover, the angle at which the lateral band edges converge in the first and/or third band regions towards the constant width at the second band region should preferably be between 130° and 170°, more preferably between 140° and 160°, most preferably between 145° and 155°.

According to the most preferred embodiment, the tolerance compensation means is at least partially, preferably entirely, formed at a second end portion which forms an outer clamping band portion overlapping a first end portion when the clamp structure is installed around the object to be fastened. In particular, the tolerance compensation means may be formed between the free end of the clamping band at the second end portion and a radial step formed in the second end portion to provide a larger radial dimension for that part of the second end portion which is adapted to overlap the first end portion of the clamping band when the clamp structure is installed around the object to be fastened. This positioning of the tolerance compensation means is close to the clamp part where the tensioning hook and the tongue receiving channel are placed and has turned out to improve the stretchability as compared to prior art solutions having the tolerance compensation elements in the longitudinal center portion.

In a particularly preferable embodiment, the clamp structure has a tensioning hook provided with a window formed by cutting-out band material in the lateral center portion of the clamping band, and the cut-out window is at least partially formed within the third band region. Thereby, the material stretchability in the third band region is supported, leading to an optimised elongation characteristic.

Similarly, the clamp structure of the embodiment may include a tongue portion formed at the first end portion of the clamping band and a tongue receiving channel formed at the second end portion of the clamping band. The tolerance compensation is then positioned such that the tongue receiving channel is at least partially formed within the first band region. This set-up has also proven helpful to achieve the desired elongation characteristic.

As to manufacturing aspects, all three band regions of the claimed tolerance compensation means can be formed by cutting band material from the normal width of the clamping band at lateral band edges. Hence, clamp structures with the tolerance compensation means of the present invention can be obtained from a flat band of steel material in a relatively simple and inexpensive cutting process.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a top view of the clamp structure according to the embodiment in a flat (unrounded) state;

FIG. 2 is a perspective view of the clamp structure shown in FIG. 1; and

FIG. 3 shows the behaviour of the clamp structure of the embodiment compared to clamp structures with other compensation elements in a displacement-force diagram obtained by a finite element analysis (FEA).

### DETAILED DESCRIPTION OF THE INVENTION

In the present specification, the terms “radial”, “axial” and “circumferential” refer to an overall geometrical form of the clamp which, in its closed state, is generally a ring having a certain radius and circumference. The clamp is designed for embracing a pipe, hose or boot which extends substantially in the axial direction.

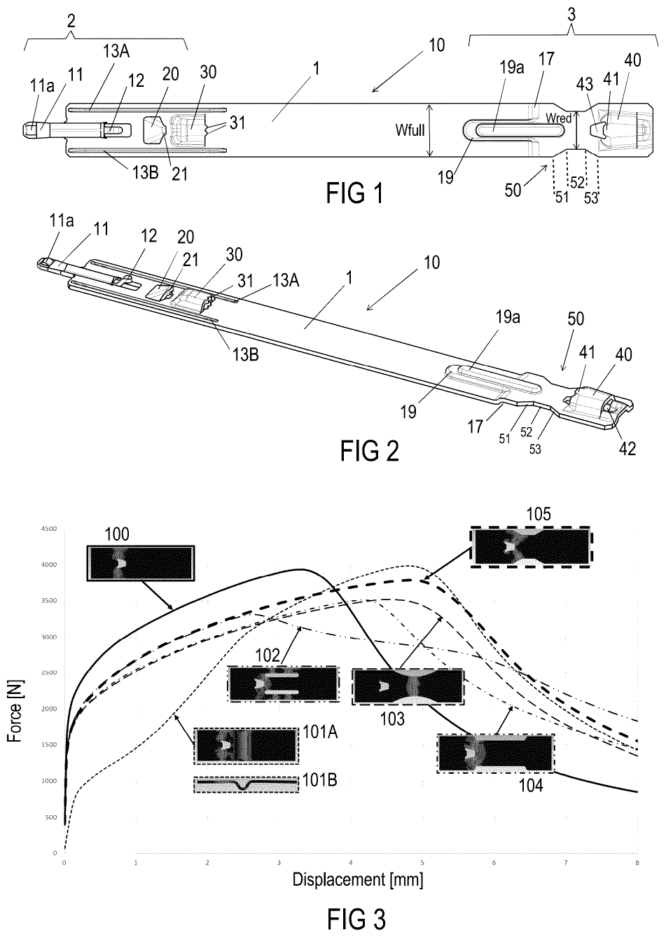

FIGS. 1 and 2 show the clamp structure 10 in a flat (unrounded) state. The clamp structure 10 is made from a flat metal band or strip 1 by various cutting and deforming or embossing steps which are generally known in the art. The tip end of the first circumferential end portion 2 has a tongue portion 11 of minimum width which is adapted to be received in a tongue channel 19 at the inside of the second end portion 3 of the band 1. The tongue portion 11 has a radial protrusion 11a to be received in a guiding channel 19a of the tongue receiving channel 19. At the end of the tongue receiving channel 19 there is a radial step 17 on both lateral sides for abutment with edges formed on both lateral sides at the root of the tongue portion 11. The height of the radial step 17 corresponds to the thickness of the flat band material 1. Therefore, the clamp structure 10 in its closed state provides a substantially stepless inner surface facing the object to be fastened.

Going from the tongue portion 11 circumferentially in the direction towards the second end portion 3 of the band 1, the clamp structure 10 has a preassembling hook 12 adapted to be received in an aperture 42 of the second tensioning hook 40 in a preassembled state in which the flat clamping band is rounded but not yet in the final closed configuration. The aperture is formed by cutting the band material in the axial direction before forming the embossed hook 40 but without taking material away from the clamping band 1.

Circumferentially next to the preassembling hook 12 are the connecting or load retaining hook 20 and the first tensioning hook 30. The connecting hook 20 has a free edge portion 21 forming the radially outermost tip end of the hook 20 and serving as an engagement tooth which is adapted to be received in the aperture 42 of the second tensioning hook 40 in the closed state of the clamp structure 10. The edge portion 21 points in the circumferential direction towards the second end portion 3 so that it hooks into the aperture 42 when the two end portions 2 and 3 are pulled circumferentially away from each other in the closed state of the clamp 1. The connecting hook 20 further has, in the circumferential direction opposite to the edge portion 21, a back surface which has a smooth radial slope and provides a ramp for the outermost end of the second end portion 3 during the closing operation of the clamp structure 10.

The first and second tensioning hooks 30, 40 are both provided with tooth-like protrusions 31, 41 facing towards each other in the circumferential direction. These tooth-like protrusions 31, 41 allow for forming an anti-slip form fit with the jaws of pliers (not shown) engaging with the first and second tensioning hooks 30, 40 in a closing operation of the clamp structure 10.

Side rails 13A, 13B are formed as additional stiffening ribs at the left and right lateral sides of at least that part of the first end portion 2 where the connecting hook 20 and the first tensioning hook 30 are formed. The side rails 13A, 13B are formed to extend generally in the longitudinal (=circumferential) direction of the band material 1 and extend preferably up to the region where the tongue portion 11 is formed. This is to avoid kinking of the tongue portion 11 during the clamp closure.

The clamp structure 10 is further provided with the tolerance compensation means 50 at the second end portion 3, more specifically between the radial step 17 and the free end of the second end portion 3. The tolerance compensation means 50 is realised by a simple but efficient reduction of the regular band width Wfull to a smaller bandwidth Wred.

In the shown embodiment, the tolerance compensation means 50 includes three consecutive band regions 51-53 along the longitudinal direction of the clamping band 1. In the first band region 51, the band width is reduced linearly and symmetrically from both lateral band edges from the full or regular band width Wfull to a reduced band width Wred. In the second band region 52, the band width stays constant at the reduced band width Wred. In the third band region 53, the band width is increased linearly and symmetrically from both lateral band edges from the reduced band width Wred to the regular band width Wfull.

The angle at which the lateral band edges of the first band region 51 meet the lateral band edges of the second band region 52, i.e., the angle which is included between the lateral band edges of the first and second band regions 51, 52 and which is opened towards outside, is about 150°. Likewise, the angle included between the lateral band edges of the second and third band regions 52, 53 is about 150°.

Modifications of the shown embodiment are possible without leaving the scope of protection. For instance, the angle mentioned above may take other values, preferably within the range of 130° to 170°. Also, the first and/or third band regions 51, 53 may decrease/increase the band width non-linearly or not in a symmetrical fashion, e.g., only on one lateral side. Also, the band width at the third band region 53 may be smaller than that at the first band region 51.

The second band region 52 extends over a larger longitudinal extension than each of the first and second band regions 51, 53 but shorter than the total longitudinal extension of the first and second band regions 51, 53 in combination. In the shown embodiment, the ratio of the longitudinal extensions of the first to third band regions 51:52:53 is roughly 3:4:3.

As can be seen best in present FIG. 1, the second tensioning hook 40 is provided with a central cut-out window 43 which protrudes into the third band region 53. In the cut-out window 43, material is taken away from a central portion of the clamping band 1. The cut-out window 43 weakens the material strength of the clamping band 1 in the center part of the third band region 53 to a desired extent. This supports the overall stretchability of the clamp structure 10 in the longitudinal direction.

Likewise, the guiding channel 19a of the tongue receiving channel 19 protrudes into the first band region 51. The guiding channel 19a has a larger radial dimension than the band portion between the radial step 17 and the free end of the second end portion 3. Thereby, the guiding channel 19a weakens the material strength of the clamping band 1 in the center part of the first band region 51 to some extent. This also supports the overall stretchability of the clamp structure 10 in the longitudinal direction.

Results of a finite element analysis (FEA) will now be discussed with reference to FIG. 3. As will be explained therein, the proposed shape of the tolerance compensation means 50 according to the present embodiment leads to better performance compared to state-of-the-art shapes.

The FEA compares the tensile behaviour of a full band 100 (black curve in FIG. 3) without any band width reduction, the proposed solution 105 (bold dashed curve) and several other configurations 101-104 (other dotted or dashed curves). For all compared configurations, a cut-out window 43 of the same size and shape has been considered in the central band width portion.

As can be seen in FIG. 3, the proposed solution 105 provides a stiff tensile behaviour, especially at low displacement values (similar to the full band 100 without any compensation element, displacement range 0-2 mm). After that (displacement range 4-5 mm), it can be noticed that the proposed solution 105 offers increased elongation as the load is increased and therefore contributing to tolerance compensation of the clamp structure 10, without a significant reduction of the load response. This results in a better overall clamping performance.

In the case of the other tolerance compensation configurations of the prior art 101, 102 and the comparative examples 103, 104, it can be seen that, compared to the proposed solution 105, the wave profile 101 elongates too much at low force values, and other geometries 102-104 provide lower force responses (strength) and lower maximum elongations before failure.

In particular, for the prior art case of tolerance compensation wave shown in a top view 101A and a longitudinal cross section in 101B, there is too much elongation at forces in the range of 500 to 3,000 N.

In the prior art case of a double slot tolerance compensation element 102, the maximum elongation before failure is below 3 mm whereas the present embodiment 105 achieves about 5 mm.

The comparative example 103 provides a curved recess without band region of constant width of reduced size. The FEA curve for this solution 103 remains entirely below that of the present solution 105. This means that the load response and the clamping force is generally weaker than in the present embodiment.

The comparative example 104 provides a much longer band region with constant width of reduced size than the present solution 105 whereas the size of the reduced width is a bit broader than the reduced size Wred of the present embodiment. Again, the load response is worse than for the present embodiment and, additionally, the maximum elongation before failure is lower, namely at around 4.3 mm.

In summary, the present invention provides an improved tolerance compensation means 50 for a clamp structure 10 formed by a clamping band 1 with first and second end portions 2, 3 adapted to overlap each other as inner and an outer clamping band portions when installing the clamp structure 10 around an object to be fastened. The tolerance compensation means 50 includes adjacent first, second and third band regions 51-53, whereas the second band region 52 has a constant band width Wred smaller than that of the first and third band regions 51, 53,

### LIST OF REFERENCE SIGNS

1 clamping band
2 first end portion
3 second end portion
10 clamp structure
11 tongue portion
11a radial protrusion
12 preassembling hook
13A, 13B side rails
17 step
19 tongue receiving channel
19a guiding channel
20 connecting hook
21 protruding edge portion
30 first tensioning hook
31 tooth projections
40 second tensioning hook
41 tooth projections
42 aperture
43 cut-out window
50 tolerance compensation means
51 first band region
52 second band region
53 third band region
full or regular width Wfull
Wred reduced width
100 reference example “full band”
101A reference example “wave”-top view
101B reference example “wave”-cross section
102 reference example “slot”
103 reference example “round recess”
104 reference example “long rectangular recess”
105 present embodiment

What is claimed is:

1. A clamp structure (10) formed by a clamping band (1) comprising:
first and second end portions (2, 3) adapted to overlap each other as inner and an outer clamping band portions when installing the clamp structure (10) around an object to be fastened,
connecting means (11, 19, 20, 30, 40) operable to mechanically interconnect the inner and outer clamping band portions, and
tolerance compensation means (50) to impart stretchability to the clamping band (1) in its longitudinal direction,
characterized in that the tolerance compensation means (50) includes the following adjacent band regions along the longitudinal direction of the clamping band (1):
a first band region (51) in which the lateral band width decreases from a first band width (Wfull) to a second band width (Wred) which is smaller than that first band width (Wfull),
a second band region (52) in which the lateral band width remains constant at the second band width (Wred), and
a third band region (53) in which the lateral band width increases to a third band width which is larger than the second band width (Wred).

2. The clamp structure (10) of claim 1, wherein the third band width is equal to the first band width (Wfull).

3. The clamp structure (10) of claim 1, wherein the longitudinal extension of second band region (52) is larger than that of the first and third band regions (51, 53) but smaller than the sum of that of the first and third band regions (51, 53).

4. The clamp structure (10) of claim 1, wherein the lateral band edges in the first and third band regions (51, 53) form an angle between 130° and 170° with the lateral band edges in the second band region (52) having the second band width (Wred).

5. The clamp structure (10) of claim 4, wherein the lateral band edges in the first and third band regions (51, 53) form an angle between 140° and 160° with the lateral band edges in the second band region (52) having the second band width (Wred).

6. The clamp structure (10) of claim 1, wherein the tolerance compensation means (50) is at least partially formed at the second end portion (3) which forms the outer clamping band portion overlapping the first end portion (2) when the clamp structure (10) is installed around the object to be fastened.

7. The clamp structure (10) of claim 1, wherein the decrease of the band width in the first band region (51) is linear.

8. The clamp structure (10) of claim 1, wherein the increase of the band width in the third band region (53) is linear.

9. The clamp structure (10) of claim 1, wherein the decrease of the band width in the first band region (51) and the increase of the band width in the third band region (53) are symmetric with respect to a longitudinal center axis of the clamping band (1).

10. The clamp structure (10) of claim 1, wherein the decrease of the band width in the first band region (51) and the increase of the band width in the third band region (53) are symmetric with respect to a cross-section through the second band region (52) orthogonal to the longitudinal direction.

11. The clamp structure (10) of claim 1, wherein
a radial step (17) is formed in the second end portion (3) of the clamping band (1) to provide a larger radial dimension for that part of the second end portion (3) which is adapted to overlap the first end portion (2) of the clamping band (1) when the clamp structure (10) is installed around the object to be fastened, and
the tolerance compensation means (50) is formed between the radial step (17) and the free end of the clamping band (1) at the second end portion (3).

12. The clamp structure (10) of claim 1, wherein
the connecting means (11, 19, 20, 30, 40) includes a tensioning hook (40) having a window (43) formed by cutting-out band material in the lateral center portion of the clamping band (1), and
the cut-out window (43) is at least partially formed within the third band region (53).

13. The clamp structure (10) of claim 1, wherein
the connecting means (11, 19, 20, 30, 40) includes a tongue portion (11) formed at the first end portion (2) of the clamping band (1) and a tongue receiving channel (19) formed at the second end portion (3) of the clamping band (1), and
at least a part (19a) of the tongue receiving channel (19) is formed within the first band region (51).

14. The clamp structure (10) of claim 1, wherein all three band regions (51-53) of the tolerance compensation means (50) are formed by cutting away band material from at lateral band edges of the clamping band (1) to reduce the width of the clamping band (1) from the first width (Wfull) to the second width (Wred).
